(19) United States
(12) Patent Application Publication
(10) Pub. No.: US 2019/0003811 A1
(43) Pub. Date: Jan. 3, 2019

(54) EXPANSION PIPE FOR BLASTING AND BLASTING METHOD THEREFOR

(71) Applicant: Weiguo MA, Gaocheng City, Hebei (CN)

(72) Inventors: Weiguo MA, Gaocheng City, Hebei (CN); Mingze MA, Gaocheng City, Hebei (CN); Guoyong ZHU, Gaocheng City, Hebei (CN); Li SHANG, Shijiazhuang City, Hebei (CN); Bin JIA, Gaocheng City, Hebei (CN)

(21) Appl. No.: 16/063,843

(22) PCT Filed: Sep. 22, 2016
(86) PCT No.: PCT/CN2016/099673

§ 371 Date: Jun. 19, 2018

(30) Foreign Application Priority Data
Sep. 30, 2015 (CN) 201510638618.5

(51) Int. Cl. F42D 1/00; F42D 5/00; F42D 3/04

(52) U.S. Cl. CPC F42D 1/00; F16L 51/00; F42D 3/04; F42D 5/00

(57) ABSTRACT

Provided are an expansion pipe for blasting and a blasting method therefor. The expansion pipe comprises a main pipe (1) of which the head and tail ends are provided with a first plug (3) and a second plug (4) and a branch pipe (2) which is fixed to the interior of the main pipe (1) by means of the first plug (3), wherein a gasification agent and an electric starter (7) mounted on the first plug (3) are provided inside the branch pipe (2), the other end of the branch pipe (2) is provided with a sealing plug (5), a connecting pipe (6) is further provided at the head of the main pipe (1), one end of the connecting pipe (6) is connected to a gas source or a water source and the other end penetrates through the first plug (3) to be in communication with the inner cavity of the main pipe (1). When the expansion pipe is used, a group of the expansion pipes are connected in a head-to-tail manner via fixing pieces (8), then a hole is punched at a blasting point, the connected and fixed expansion pipe group is placed into the hole, the opening of the hole is sealed with cement, and finally the electric starter (7) is started through a remote controller outside a dangerous range, and the gasification agent is ignited by the electric starter (7), causing water gasification or air expansion inside the main pipe (1), such that the expansion pipes are blasted.

### BACKGROUND OF THE INVENTION

### Technical Field

The present invention relates to the field of mining technologies, and in particular, to an expansion pipe for blasting, and a blasting method therefor.

### Background

At present, in mining technology, explosive blasting is the commonly used means. Mine blasting originates from the development and extension of blasting, which is defined as a technology that uses the compression, loosening, destruction, throwing and killing effects caused by an explosion of explosives in air, water, and earth-rock media or objects to achieve an intended purpose.

1) Blasting classifications in open-pit mines are as follows: deep-hole blasting for steps, secondary blasting for large blocks and foundations, controlled blasting near slopes, and the like.

2) There are the following blasting methods: millisecond blasting, tight-face blasting, controlled blasting, shallow-hole blasting, and secondary blasting with an exposed explosive pack.

A mining manner using explosive blasting highly requires the technical means used by operators during the operation. Due to the instability of explosives, they are prone to explode at high temperature and a great impact, and in the case of sparks. Therefore, danger easily occurs during operation. Even if a professional blasting team conducts blasting, there still exist many unsafe factors, failing to effectively guarantee the safety of the operators. In addition, the explosive, as a restricted item, has strict requirements in storage, management, and use; and requires investment of a lot of manpower and material resources for protection. The cost of use is high. Moreover, the examination procedures in the use of explosives in China are cumbersome and rigorous, and thus it is inconvenient to use the explosives. Therefore, there is a need for a low-cost, convenient, and safe blasting device to replace explosive blasting.

### SUMMARY OF THE INVENTION

The present invention overcomes the defects in existing explosive blasting; and provides an expansion pipe for blasting and a blasting method therefor, where no inflammables and explosives are disposed inside the expansion pipe. There are no security risks during operation, and the structure is simple and the cost is low.

The technical solutions of the present invention are as follows:

An expansion pipe for blasting is provided. The expansion pipe includes: a main pipe of which the head and tail ends are provided with a first plug and a second plug, and a branch pipe which is fixed to the interior of the main pipe by means of the first plug, where a gasification agent and an electric starter mounted on the first plug are provided inside the branch pipe, the other end of the branch pipe is provided with a sealing plug, a connecting pipe is further provided at the head of the main pipe, one end of the connecting pipe is connected to a gas source or a water source and the other end penetrates through the first plug to be in communication with the inner cavity of the main pipe.

A gas vent is further provided at the head of the main pipe, where an end cap is mounted in the gas vent in a sealed manner, and an inner wall of the gas vent is in threaded connection with an outer wall of the end cap.

The main pipe, the branch pipe, the first plug, the second plug, and the sealing plug are all made by using a PVC material.

The connecting pipe is made by using a metal material.

A blasting method for the expansion pipe for blasting described above is provided. The method includes the following steps:

a. connecting a group of expansion pipes in a head-to-tail manner, where a connecting pipe connects main pipes of two adjacent expansion pipes, a second plug in an expansion pipe at the tail end is completely closed, and a connecting pipe in a first plug in an expansion pipe at the foremost end connects the interior with the exterior of its main pipe;

b. punching a hole at a blasting point with a drilling machine, where the hole is able to accommodate the expansion pipe group connected in a head-to-tail manner;

c. placing the expansion pipe group into the hole punched in step b, and sealing an opening of the hole with cement; and

d. starting an electric starter with a remote controller, to ignite a gasification agent inside a branch pipe, the temperature of the gasification agent rising, and the high-temperature branch pipe causing high-temperature gasification of water or air inside the main pipe, to result in expansion; and finally, implementing blasting of the expansion pipes.

In step a, the expansion pipes are fixedly connected via fixing pieces, where the fixing piece is a pipe fitting with two ends both provided with outer threads and a middle portion of a hexagonal-prism structure. A first plug and a second plug of the expansion pipe are each provided with a threaded hole, the threads at the two ends of the fixing piece are respectively in threaded connection with the second plug of a former expansion pipe and the first plug of a latter expansion pipe. The connecting pipe is located in the fixing piece, and two ends of the connecting pipe are separately in communication with the interiors of the two connected expansion pipes.

In step a, the expansion pipes are fixedly connected via fixing pieces, where the fixing piece is a pipe fitting with two ends both provided with inner threads. The head and tail ends of each expansion pipe are both provided with outer threads. The threads at the two ends of the fixing piece are respectively connected to outer threads at the tail end of a former expansion pipe and outer threads at the head end of a latter expansion pipe. The connecting pipe is located in the fixing piece, and two ends of the connecting pipe are separately in communication with the interiors of the two connected expansion pipes.

Mass ratios of ingredients of the gasification agent are as follows: nitroguanidine of 40% to 50%, copper nitrate basic of 40% to 50%, ferric oxide of 3% to 7%, and ammonium perchlorate of 3% to 7%.

Mass ratios of ingredients of the gasification agent are preferably as follows: nitroguanidine of 45%, copper nitrate basic of 45%, ferric oxide of 5%, and ammonium perchlorate of 5%.

In step d, after the gasification agent is ignited by the electric starter, the heating temperature thereof within 40 ms is not lower than 400° C.

The beneficial effects of the present invention are as follows: The blasting method according to the present invention does not require cumbersome examination procedures; and also does not require professional personnel to perform management, storage, and operations. It is rather convenient and easy to prepare the blasting. Moreover, the expansion pipe for blasting is neither an inflammable nor an explosive, and thus the safety of workers who bury the pipe can be guaranteed during operation. A remote controller can be used to control the blasting. Therefore, the operation is easy and safe, and technical requirements on the operators are not high.

### BRIEF DESCRIPTION OF THE DRAWINGS

FIG. 1 is a schematic structural diagram of an expansion pipe according to the present invention;

FIG. 2 is a schematic structural diagram showing a connection between expansion pipes in Embodiment 1 of the present invention; and

FIG. 3 is a schematic structural diagram showing a connection between expansion pipes in Embodiment 2 of the present invention.

Meanings of the reference numerals: 1. main pipe, 2. branch pipe, 3. first plug, 4. second plug, 5. sealing plug, 6. connecting pipe, 7. electric starter, 8. fixing piece, 9. gas vent, and 10. end cap.

### DETAILED DESCRIPTION

With the gradual improvement of China's production safety situation, people's awareness and expectations towards safety also increasingly rise. Especially, as the mining industry continuously and rapidly develops in recent years, mine employees have reached a considerable scale, and the country also attaches great importance to safety production in mines. The mining operation mode for open-pit mines mainly relies on blasting mining, which has the production advantages of high efficiency, accuracy, and rapidness, and can bring considerable economic benefits to mining enterprises. With the continuous development of production, the difficulty in surface blasting gradually increases, but the danger has not been substantially reduced. We should also know that, the blasting safety problem in mines is still a major hidden danger in the mining process, and the public nuisance produced by the blasting is also a reality, which causes serious damage to the ecological environment on which people depend for their survival. Security accidents still occur from time to time. Therefore, we should strengthen effective management on blasting safety while strengthening mine production. Therefore, for the purpose of controlling blasting vibration intensity and effectively suppressing flying stones produced in blasting, blasting parameters need to be rationally selected, to effectively reduce the destructive impact of blasting vibration on the surrounding environment.

The safety of the blasting work is the top priority in the entire mining work, and concretely manifests people-oriented idea in the work. Due to the complexity of the blasting environment and work conditions, it is difficult to use a fixed mode for the safety of the surface blasting. In specific circumstances, it is further required to determine the safety according to specific conditions. Therefore, it is necessary to strengthen the safety management on the blasting work, enhance the initiative and predictability for production safety, and thoroughly avoid the safety accidents in the blasting work.

The present invention relates to an expansion pipe for blasting and a blasting method therefor, which are used to exploit mine resources by means of blasting. The expansion pipe includes: a main pipe 1 of which the head and tail ends are provided with a first plug 3 and a second plug 4, and a branch pipe 2 which is fixed to the interior of the main pipe 1 by means of the first plug 3, where a gasification agent and an electric starter 7 mounted on the first plug 3 are provided inside the branch pipe 2, the other end of the branch pipe 2 is provided with a sealing plug 5, a connecting pipe 6 is further provided at the head of the main pipe 1, one end of the connecting pipe 6 is connected to a gas source or a water source and the other end penetrates through the first plug 3 to be in communication with the inner cavity of the main pipe 1. Expansion pipes of the foregoing structure are connected to form an expansion pipe group used for blasting.

### Embodiment 1

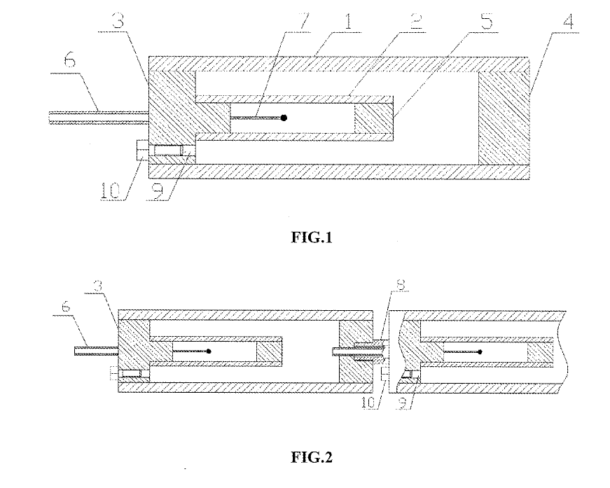

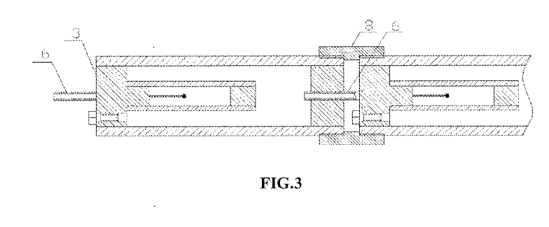

As shown in FIG. 1 and FIG. 2, the main pipe 1, the branch pipe 2, the first plug 3, the second plug 4, and the sealing plug 5 are all made by using a PVC material. The connecting pipe 6 is made by using a metal material. The gasification agent in the branch pipe 2 includes the following ingredients according to a mass ratio: nitroguanidine of 45%, copper nitrate basic of 45%, ferric oxide of 5%, and ammonium perchlorate of 5%. The length and the diameter of each expansion pipe are respectively 80 cm and 90 mm. A blasting method for the expansion pipe of the foregoing structure specifically includes the following steps:

a. A group of expansion pipes are connected in a head-to-tail manner. Two adjacent expansion pipes are fixedly connected via a fixing piece 8, where the fixing piece 8 is a pipe fitting with two ends both provided with outer threads and a middle portion of a hexagonal-prism structure. A first plug 3 and a second plug 4 of the expansion pipe are each provided with a threaded hole, the threads at the two ends of the fixing piece 8 are respectively in threaded connection with the second plug 4 of a former expansion pipe and the first plug 3 of a latter expansion pipe. The connecting pipe 6 is located in the fixing piece 8, and two ends of the connecting pipe are separately in communication with the interiors of the two connected expansion pipes. The threaded hole of the second plug 4 in an expansion pipe at the tail end is closed. The connecting pipe 6 penetrates through the first plug in an expansion pipe at the front end. The main pipe 1 of the expansion pipe may be filled with water or air. No operation is required for air filling. The air exists in the assembled expansion pipe group. If water is used as an expansion-blasting substance to fill the pipe, an end cap 10 on each expansion pipe needs to be unscrewed, and the water is injected through a connecting pipe 6 in an expansion pipe on the foremost end. Each time when an expansion pipe is filled, the end cap 10 is screwed for sealing. After the main pipe 1 of the expansion pipe on the foremost end is fully filled, an external port of the connecting pipe 6 is sealed.

b. A hole is punched at a blasting point with a drilling machine, where the diameter of the punched hole is 90 cm to 100 cm and the depth thereof is 1 m to 10 m, and the hole is able to accommodate the expansion pipe group connected in a head-to-tail manner.

c. The expansion pipe group is placed into the hole punched in step b, and an opening of the hole is sealed with cement.

d. An electric starter 7 is started with a remote controller, to ignite a gasification agent inside the branch pipe 2. The temperature of the gasification agent rises. After the gasification agent is ignited by the electric starter 7, the heating temperature thereof within 40 ms is not lower than 400° C. The high-temperature branch pipe 2 causes high-temperature gasification of water or air inside the main pipe 1, to result in expansion, and then the expansion pipe is blasted. Finally, the mine is blasted at the blasting point, to conduct mining.

### Embodiment 2

As shown in FIG. 1 and FIG. 3, a main pipe 1, a branch pipe 2, a first plug 3, a second plug 4, and a sealing plug 5 are all made by using a PVC material. A connecting pipe 6 is made by using a metal material. A gasification agent in the branch pipe 2 includes the following ingredients according to a mass ratio: nitroguanidine of 45%, copper nitrate basic of 45%, ferric oxide of 5%, and ammonium perchlorate of 5%. The length and the diameter of each expansion pipe are respectively 80 cm and 90 mm. A blasting method for the expansion pipe of the foregoing structure specifically includes the following steps:

a. A group of expansion pipes are connected in a head-to-tail manner. Two adjacent expansion pipes are fixedly connected via a fixing piece 8, where the fixing piece 8 is a pipe fitting with two ends both provided with inner threads. The head and tail ends of each expansion pipe are both provided with outer threads. The threads at the two ends of the fixing piece 8 are respectively connected to outer threads at the tail end of a former expansion pipe and outer threads at the head end of a latter expansion pipe. The connecting pipe 6 is located in the fixing piece 8, and two ends of the connecting pipe are separately in communication with the interiors of the two connected expansion pipes. When the main pipe 1 of the expansion pipe is filled with water, the water is injected to main pipes 1 of an expansion pipe group through the connecting pipe 6 in the expansion pipe at the foremost end, and end caps 10 are not unscrewed. Because a gas vent 9 is not used, an injection time is longer than that in Embodiment 1. An external port of the connecting pipe 6 is sealed after the injection is completed. Because the fixing piece 8 fixedly connects the outer circumferences of the two adjacent expansion pipes, the expansion pipes in the expansion pipe group are tightly fastened, and do not easily break or loosen during carrying or use. The main pipe 1 of the expansion pipe may also be filled with air, and the injection operation is not required. An assembly time is the same as that in Embodiment 1, but the assembly manner of this embodiment brings a securer effect than that in Embodiment 1.

b. A hole is punched at a blasting point with a drilling machine, where the diameter of the punched hole is 90 cm to 100 cm and the depth thereof is 1 m to 10 m, and the hole is able to accommodate the expansion pipe group connected in a head-to-tail manner.

c. The expansion pipe group is placed into the hole punched in step b, and an opening of the hole is sealed with cement.

d. An electric starter 7 is started with a remote controller, to ignite a gasification agent inside the branch pipe 2. The temperature of the gasification agent rises. After the gasification agent is ignited by the electric starter 7, the heating temperature thereof within 40 ms is not lower than 400° C. The high-temperature branch pipe 2 causes high-temperature gasification of water or air inside the main pipe 1, to result in expansion, and then the expansion pipe is blasted. Finally, the mine is blasted at the blasting point, to conduct mining.

In the present invention, the main pipe is filled with water or air as an expansion-blasting substance, which replaces the conventional explosive. Personnel and capital investments in preservation, storage, and management are greatly reduced, and related departments are not required to give approval and put on records, simplifying the procedures for use. In addition, components of the expansion pipe are easily obtained, and the costs can be reduced accordingly. Due to the absence of flammables and explosives, the possibility of accidents is greatly reduced during a blasting preparation phase, effectively ensuring the safety of operators. The expansion pipe can be fast assembled, and multiple expansion pipes are combined into a group for blasting. The power of blasting can be controlled through a combination. Moreover, because of the characteristics of water gasification or air expansion under high temperature, as compared with the conventional blasting manner, the use of such an expansion pipe in mine blasting causes relatively small blasting sound; does not produce flying stones, dust, shock waves, blast waves, and harmful gas; and hardly affects the environment near the blasting point. Therefore, the present invention is suitably popularized and applied in the related filed.

Before the blasting work, it is necessary to accurately know the original conditions of the blasting area; and to make detailed understanding of the topography, geological conditions, surrounding buildings and personnel flows of the blasting area. In addition, it is required to take effective precautionary measures against existing problems.

In order to highly ensure the safety, when using the expansion pipe of the present invention for blasting, it is also necessary to accurately determine a danger range of the blasting area. The danger range can be calculated according to a calculation formula regarding blasting, but additionally needs to meet the range condition of 200 m to 250 m of a danger radius under normal circumstances. When surface blasting is conducted, the range of the danger radius thereof should be from 350 m to 400 m. During determining of the danger range of deep-hole blasting, impacts of ground vibration waves and blast waves should be taken into consideration, and a safety distance of flying stones also needs to be measured and calculated. The danger ranges of both deep-hole blasting and shallow-hole blasting should be determined accurately.

The quality of the blasting work also has a great impact on the safety of blasting. In practice, except for a few geological reasons, most of the blasting accidents are caused by an unqualified blasting work, such as improper network connection, unqualified blocking, foreign matters at an opening of a blast hole, and the like, which may all cause blasting accidents. In addition, it is rather important to set an alert at the blasting site. The safety of personnel in the event of an emergency should be taken into consideration. In a word, there must be a contingency plan.

In addition to the above measures, accident prevention measures also need to be prepared for blasting of open-pit mines.

The determining the blasting damage range and the safety distance mainly includes the following aspects:

1) A safety distance of ground shaking in mine blasting is determined. In this case, surrounding buildings need to be taken into consideration, and a suitable blasting distance is selected according to tremors that the buildings can withstand. It is found through scientific research that different buildings can withstand different safe vibration speeds. For example, the safe vibration speed that hydraulic tunnels can withstand is 8 cm/s, while traffic tunnels are more stable than the hydraulic tunnels and can withstand the vibration speed of 14 cm/s. Mine roadways generally have relatively high stability. Among the mine roadways, roadways having rational and stable exterior-protected structures can withstand the vibration speed of up to 28 cm/s. These projects must be checked if existing near the blasting site.

2) A safety distance of air blast waves is determined. The safety distance is determined mainly according to a safety distance with respect to the ground buildings, an air blast wave overpressure value calculation and control standard, blasting noise, a directional effect and an atmospheric effect of the air blast waves.

3) A safety distance of scattering of some broken stones is determined. During surface blasting, some stones are scattered far away and endanger the surrounding people, livestock and buildings. Therefore, this situation must be focused on during blasting.

Blasting parameters are rationally determined as follows:

1) It is required to determine the geological construction, hydrogeology, lithology, and special geology of the mine lot; and then conduct comprehensive analysis and study.

2) Various means are used when necessary, supplemented by necessary artificial intelligence equipment, such as satellite photography, remote sensing technology, and the like, to obtain accurate geological structure information of the blasting area. Thus, the mineral distribution structure in this area can be conveniently analyzed and a reasonable blasting manner can be easily determined.

3) When blasting is to be conducted in mine lots where the geological structure is special and the surrounding buildings are relatively weak, it is necessary to carefully select a work solution, take measures to perform field verification on the impacts of blasting, and make comprehensive discussions, so that an optimal solution is used to guarantee the stability of local buildings and surrounding geological features.

The blasting work shall be standardized. The operations must be performed strictly according to the blasting operation procedures. The blasting must be carried out by personnel who have undergone professional training in blasting and have obtained the blasting qualifications. Hole arrangement, hole drilling, acceptance inspection, explosive loading, line connection, and detonation are completed under the guidance of blasting engineers. The design is timely adjusted and modified against new conditions and new problems that occur in the work, to ensure the final achievement of design requirements. Only in this way can a satisfactory blasting and safety effect be achieved.

Post-blasting inspection is made and experiences are summed up:

Post-blasting inspection about the following aspects is made: It is checked whether there is a blasting miss, remaining explosives, dangerous slopes, and dangerous stones; and whether a blast heap is stable. Experiences are summed up timely, to assess the blasting effect. An experienced blaster or engineering technician takes charge of the inspection.

In units where blasting operations are frequently carried out, it is necessary to organize safety training for the personnel participating in the blasting and to strengthen prevention of blasting accidents, which mainly includes the following aspects:

1) It is necessary to strengthen the training of blasting designers' capabilities and strengthen the team leader's safety management capabilities, so that their professional qualities can be improved.

2) It is necessary to strengthen the safety education for blasting operators, attach importance to daily safety education of the team, raise their safety awareness, and enhance their initiative in consciously complying with various safety systems, thereby improving the quality of the blasting work.

3) For the existence of hidden dangers, it is necessary to make strict investigation and give punishment, and to fully implement the responsibility system and measures for production safety.

4) Based on the continuous advancement of science and technology, the use of reliable blasting devices is constantly discussed, and an advanced blasting method is adopted to improve the safety of the blasting work.

In order to enhance people's rational understanding of safety, it is required to set safety goals and implement management on the safety goals, which includes the following steps:

1) Set safety goals: □ creation of high-quality safety and civilization engineering for the blasting project; and \textcircled{2} no deaths and no loss accidents of key equipment during the blasting work.

2) Decompose the safety goals: The established safety goals are implemented in several stages, and usually, an assessment period is set to one year. With regard to the set safety goals, they are decomposed in the form of a safety responsibility agreement and the responsibility agreement is signed at each level, until it is passed on to people.

The security accountability system should be continuously strengthened, and strictly enforced in the production practice. The offenders should be seriously punished, so that everyone can establish a strong awareness of safety responsibilities.

Mining by means of blasting also affects the surrounding environment, which is mainly reflected in the following aspects:

1) Impacts on the ecological environment and landscape: Surface exfoliation of the ground before ore mining may change the original ecological environment, such as, the soil and vegetation. After mining, these original landforms are unrecoverable.

2) Impacts of heaping of waste stones: The amount of mine spoils exfoliated in mining is huge. In a general case, the spoils are heaped in a selected spoil dump in a certain scale. With certain inducements, the spoils may cause a series of natural disasters. The spoil heap may also occupy the land with good vegetation. After ore mining, the spoil dump can be ecologically restored.

3) Water loss and soil erosion: In the process of mine construction and exploitation, the original topography and landform are directly changed, vegetation is destroyed, the earth's surface is disturbed, and the erosion resistance of the original surface is reduced. In addition, some waste stones and spoils are dumped into a gully or ravine, causing water loss and soil erosion.

4) Impacts of blasting vibration and noise: The major source of vibration during limestone mining is mine blasting. The ground vibration waves produced in the blasting cause vibration of the surrounding areas. Within the distance of 200 m from the blasting point, the vibration intensity is 5 degrees; and the vibration intensity is about 3 to 4 degrees at the distance of 400 m. The vibration caused by blasting is related to many factors such as the strike direction of rock strata, faults, cleavage, height difference, and explosiveness. The blasting vibration may cause damage to buildings and structures around the blasting area.

Mine blasting also produces flying stones. Reasons for the production of the flying stones include: a poorly plugged hole, an uneven rock mass, and inaccurate minimal resistance to the explosive pack. The range of flying stones produced by blasting of a limestone mine is around 100 m. It is stipulated in Safety Regulations for Blasting Practices that, the blasting safety cordon for the limestone mine is 200 m outside the mining boundary. Therefore, it is rather conservative and safe to delimit the blasting safety cordon by a distance of 200 m. In addition, the blasting noise also has a negative impact on the people living around the mine. The intensity of a noise source in blasting of limestone mines can reach up to 110 dB, and the noise intensity in ore crushing is about 100 dB.

5) Impacts of dust: The dust produced during mining is mainly limestone particles, and the main component thereof is calcium carbonate. The dust is also produced during blasting, crushing, and transportation. The dust has impacts on human body, plants, and soil. The main component harming the human body is floating dust with a particle size of 10 μm, which mainly harms the human respiratory system. The content of SiO₂ in limestone dust is low, and the proportion of 10 μm floating dust is small, causing a small degree of harm. The impact on plants refers to that, the accumulated dust that falls on the surface of the plants affects shining of the sun on the plants. If the dust is wet, a “thin shell” is formed on the surface of crops and affects the use of light by plants, reducing the efficiency of photosynthesis. The elements contained in the dust also affect the growth of the plants. The impact on soil refers to an impact on soil chemical elements, the pH value, porosity, and surrounding environment.

In order to prevent and mitigate the above-mentioned hazards, it is necessary to formulate countermeasures for ecological environmental protection, which mainly include the following aspects:

1) Draw up an ecological environmental protection plan: Surface mining of limestone has a great impact on the ecological environment. In order to curb the destruction of water and soil resources, to protect, restore and compensate the ecological system, and to ensure the sustainable use of water and land resources, the construction unit should draw up an ecological environmental protection plan; take active and reliable ecological environmental protection measures; adopt a combination of preventive and management measures, and a combination of engineering measures and biological measures, to minimize the impact on the ecological environment.

2) Make a reasonable work solution: The design department and the owner should formulate a reasonable work plan based on the ecological protection. During the work, it is required to minimize the disturbance to the ground, balance the excavation amount and the filling amount, and arrange the excavation amount and the filling amount according to the plan. The excavation amount must be transported to the filling site in time, and be timely paved and compacted, to reduce wind erosion and water erosion. In addition, it would be best to avoid excavation during the rainy season. The field from which the soil and stones are taken should be timely leveled and compacted, and then grass is planted to cover the compacted surface. The work sequence is determined according to the water and soil conservation plan. According to the principle of first underground and then ground, first deep and then shallow, and first trunk line and then branch line, the distribution of all types of pipelines is coordinated, and it is best to complete the work in one attempt, to avoid repeated excavation. The soil used to fill the pipeline field should be compacted and the pipeline field should be timely leveled up. The soil used to fill the trench should be well compacted, and further a water-proof layer needs to disposed on its surface layers (the bottom and the walls of the trench). Currently useless spoils should be properly stockpiled and a fence must be set up. The spoils are not allowed to be discarded at will.

3) Engineering measures: Centralized treatment should be taken for the spoils in the waste-rock yard, and occupation of land vegetation should be minimized. Large waste stones are used to cover the surface of the waste-rock yard and the coverage thickness is above 1.5 m, to facilitate the infiltration of water and dredge the rainwater in the waste-rock yard. The spoils are horizontally heaped in sections from top to bottom, and then a roller is used to roll them, to compact the loose soil and timely level the waste rocks. Dams are set in grades, and safety and stability of the dam bodies are ensured. A flood interception ditch is set up on the top of the waste-rock yard, to avoid the waste-rock yard from being flooded. On both sides of a newly built and renovated road in the mine lot, slope protection measures and road protection measures are taken to prevent soil erosion, collapse and landslide. Simple protective measures are taken for steep slopes and dams caused by the temporary work. A water and soil protection fence is set up, to ease drainage and reduce soil erosion.

4) Biological measures: A segregating green belt is set between a blasting safety margin and a mining boundary in the mine, with the width of 50 m to 150 m. Plants suitable for the local area are planted, trees are planted on both sides of the transportation road in the mine lot to green the road, and grass is planted on the slopes and roadbeds. The final steps and slops are compacted; and then arbores, shrubs, and grass are planted thereon, to restore vegetation. After the mining is completed, the soil should be timely covered and the vegetation should be timely restored, to conduct water conservation and forest construction in the entire mine.

5) Environmental management and surveillance: Relevant departments should establish a special environmental protection mechanism, to provide environmental training and education for blasting operators, prohibit the blasting operators from entering non-construction areas, and try to carry out activities that has the minimum impact on the environment. The relevant departments should further supervise the blasting operation unit to implement an environmental management plan, and to carry out regulations and standards related to environmental management; coordinate departments to do a good job in environmental protection; and take charge of construction and acceptance inspection of ecological protection facilities, and inspection and supervision of operation conditions.

The impacts of mining on the ecological environment are manifold. It is necessary to do a good job in the analysis of environmental impacts with reference to the guidance of environmental impact assessment and the environmental actuality of the current region, as well as the characteristics of the development project, and according to the grasped ecological environment issues. Thus, the characteristics of the environmental impacts in the current region can be fully understood, and corresponding ecological environmental protection measures are put forward, such that the humans, resources, and environment are harmonized to realize the sustainable development of mine lots.

What is claimed is:

1. An expansion pipe for blasting, comprising: a main pipe (1) of which the head and tail ends are provided with a first plug (3) and a second plug (4), and a branch pipe (2) which is fixed to the interior of the main pipe (1) by means of the first plug (3), wherein a gasification agent and an electric starter (7) mounted on the first plug (3) are provided inside the branch pipe (2), the other end of the branch pipe (2) is provided with a sealing plug (5), a connecting pipe (6) is further provided at the head of the main pipe (1), one end of the connecting pipe (6) is connected to a gas source or a water source and the other end connects with the inner cavity of the main pipe (1) through the first plug.

2. The expansion pipe for blasting according to claim 1, wherein a gas vent (9) is further provided at the head of the main pipe (1), an end cap (10) is mounted in the gas vent (9) in a sealed manner, and an inner wall of the gas vent (9) is in threaded connection with an outer wall of the end cap (10).

3. The expansion pipe for blasting according to claim 1, wherein the main pipe (1), the branch pipe (2), the first plug (3), the second plug (4), and the sealing plug (5) are all made by using a PVC material.

4. The expansion pipe for blasting according to claim 1, wherein the connecting pipe (6) is made by using a metal material.

5. A blasting method for the expansion pipe for blasting according to claim 1, wherein the method comprises the following steps:
a. connecting a group of expansion pipes in a head-to-tail manner, wherein a connecting pipe (6) connects main pipes (1) of two adjacent expansion pipes, a second plug (4) in an expansion pipe at the tail end is completely closed, and a connecting pipe (6) in a first plug (3) in an expansion pipe at the foremost end connects the interior with the exterior of its main pipe (1);
b. punching a hole at a blasting point with a drilling machine, wherein the hole is able to accommodate the expansion pipe group connected in a head-to-tail manner;
c. placing the expansion pipe group into the hole punched in step b, and sealing an opening of the hole with cement; and
d. starting an electric starter (7) with a remote controller, to ignite a gasification agent inside a branch pipe (2), the temperature of the gasification agent rising, and the high-temperature branch pipe (2) causing high-temperature gasification of water or air inside the main pipe (1), to result in expansion; and finally, implementing blasting of the expansion pipes.

6. The blasting method according to claim 5, wherein in step a, the expansion pipes are fixedly connected via fixing pieces (8), the fixing piece (8) being a pipe fitting with two ends both provided with outer threads and a middle portion of a hexagonal-prism structure; a first plug (3) and a second plug (4) of the expansion pipe are each provided with a threaded hole, the threads at the two ends of the fixing piece (8) are respectively in threaded connection with the second plug (4) of a former expansion pipe and the first plug (3) of a latter expansion pipe; the connecting pipe (6) is located in the fixing piece (8), and two ends of the connecting pipe are separately in communication with the interiors of the two connected expansion pipes.

7. The blasting method according to claim 5, wherein in step a, the expansion pipes are fixedly connected via fixing pieces (8), the fixing piece (8) being a pipe fitting with two ends both provided with inner threads; the head and tail ends of each expansion pipe are both provided with outer threads; the threads at the two ends of the fixing piece (8) are respectively connected to outer threads at the tail end of a former expansion pipe and outer threads at the head end of a latter expansion pipe; the connecting pipe (6) is located in the fixing piece (8), and two ends of the connecting pipe are separately in communication with the interiors of the two connected expansion pipes.

8. The blasting method according to claim 5, wherein mass ratios of ingredients of the gasification agent are as follows:
nitroguanidine of 40% to 50%, copper nitrate basic of 40% to 50%, ferric oxide of 3% to 7%, and ammonium perchlorate of 3% to 7%.

9. The blasting method according to claim 5, wherein mass ratios of ingredients of the gasification agent are as follows: nitroguanidine of 45%, copper nitrate basic of 45%, ferric oxide of 5%, and ammonium perchlorate of 5%.

10. The blasting method according to claim 5, wherein in step d, after the gasification agent is ignited by the electric starter (7), the heating temperature thereof within 40 ms is not lower than 400° C.
